(19) United States
(12) Patent Application Publication
(10) Pub. No.: US 2004/0160055 A1
(43) Pub. Date: Aug. 19, 2004

(54) Pipe seal

(76) Inventor: John Reginald Newton, Grange-over-Sands (GB)

Correspondence Address: Howard W Milton Jr, Howard and Howard Attorneys, The Pinehurst Office Center Suite #101, 39400 North Woodward Avenue, Bloomfield Hills, MI, 48304-5151, US

(21) Appl. No.: 10/475,889

(22) PCT Filed: Apr. 25, 2002
(86) PCT No.: PCT/GB02/01857

(30) Foreign Application Priority Data
Apr. 26, 2001 (GB) 0110206.0

(51) Int. Cl. F16L 35/00

(52) U.S. Cl. 285/21.1; 285/139.1; 285/192; 285/216

(57) ABSTRACT

A pipe seal is disclosed which comprises a main body portion (1) adapted to be fixed to the wall (12) of a chamber, tank, or the like, a face plate (6) adapted to be secured to the body portion to surround, in use, a pipe (14) to be sealed, the body and face plate between them housing a deformable member (9) in contact with a seal (8), such that, on forcing the face plate toward the body portion, the deformable member, in use, deforms and presses the seal into sealing contact with the pipe. The design of this pipe seal allows the pipe to enter the chamber wall at an angle of, for example, up to 12 degrees from a right angle. Hence the end of a pipe could generate a cone of movement with an included angle of 24 degrees. The seal therefore permits considerable positional movement of the pipe to allow connection of the pipe to its termination point within the chamber.

This invention relates to a pipe seal and more particularly relates to a seal for a pipe entering a chamber at an angle

Throughout industry there are many examples of pipes and cables terminating at equipment housed within tanks or chambers. Typically these chambers are thin-walled and at the point of entry the pipe is sealed to the tank wall. In installations where the tank or chamber is below ground level, there is a need to seat the pipe to prevent the ingress of ground water. More recently, in view of environmental legislation, it has become increasingly important to ensure that any chemicals, held within or spilled within the chamber, are contained and do not enter the ground and cause contamination.

Pipes entering a chamber either connect to equipment within the chamber or form a junction with other pipes. In either case it is not always possible for the pipe to enter at 90 degrees to the chamber wall. If a pipe can enter at 90 degrees then there are many suitable pipe seals available. If this is not the case then a more specialised pipe seal is required.

Considering the case where the pipe enters at an angle of less than 90 degrees, the end of the pipe can, if rotated, create a cone of movement and at any point within that cone could be attached to the equipment located in the chamber. The conventional type of seal for this application employs a rubber bellows seal which is clamped to a seal body attached to the chamber wall, and then clamped to the pipe. Seals of this type are very effective at allowing the vital rotational movement. However, rubber bellows are a source of weakness as the rubber deteriorates over time, has limited chemical resistance, and is prone to physical damage. Furthermore a damaged rubber bellows is difficult to repair and replacement requires that pipes, which may well be carrying some form of liquid, must be disconnected which is a difficult and often very expensive task.

There is therefore a need for a pipe seal which offers the flexibility of the bellows type seal whilst eliminating the problems associated with the bellows type design. The invention seeks to provide such a pipe seal.

According to the present invention there is provided a pipe seal which comprises

a main body portion adapted to be fixed to the wall of a chamber, tank, or the like,

a face plate adapted to be secured to the body portion to surround, in use, a pipe to be sealed,

the body and face plate between them housing a deformable member in contact with a seal,

such that, on forcing the face plate toward the body portion, the deformable member, in use, deforms and presses the seal into sealing contact with the pipe.

The design of this pipe seal allows the pipe to enter the chamber wall at an angle of, for example, up to 12 degrees from a right angle. Hence the end of a pipe could generate a cone of movement with an included angle of 24 degrees. The seal therefore permits considerable positional movement of the pipe to allow connection of the pipe to its termination point within the chamber.

The main body portion way be generally annular in shape and may be attached to the chamber wall by, e.g., a ring nut. Alternatively the body could be welded or heat sealed to the wall, especially where the latter is made of a plastics material.

The face plate may be attached to the body by one or more, preferably a plurality of, bolts and associated nuts. Tightening the nuts and bolts may deform the deformable member in the cavity formed between the plate and body. The face plate may also be generally annular in shape as it, together with the main body, surround the pipe in use. Alternatively, where smaller diameter pipes are to be sealed, the deformable member and seal may be contained within a cassette arrangement. The face plate may be replaced by a clamping ring and the bolts dispensed with as will be described more fully hereinafter. This has the advantage that a number of pipe sizes can be accommodated merely by replacing the cassette.

The deformable member is preferably a ring of elastomeric material such as nitrile rubber. The cavity in which it is held is open along an annular portion adjacent the pipe so as to contact the seal and force it against the pipe.

The seal may also be of in elastomeric material but it is preferred to use a chemically inert material such as polytetrafluoroethylene, e.g. Teflon. The seal is preferably in the form of a plurality of split rings so the it can be removed and replaced when necessary without having to disconnect the pipework.

A pipe passing through a chamber wall is circular in cross section when at 90 degrees to the wall. If the pipe deviates from being at right angles to the wall, then the cross section of the pipe, at the wall face, becomes an oval. The implication of this fact is that a seat must be able to accommodate the degree of ovality which occurs. The seal of this invention permits the pipe to be up to, for example, 12 degrees from a right angle. For example a pipe of 75 mm diameter would generate an oval with corresponding dimensions of A=75 mm and B=76.68 mm at 12 degrees from a right angle.

The invention will now be described further, by way of example, with reference to the accompanying drawings, in which:

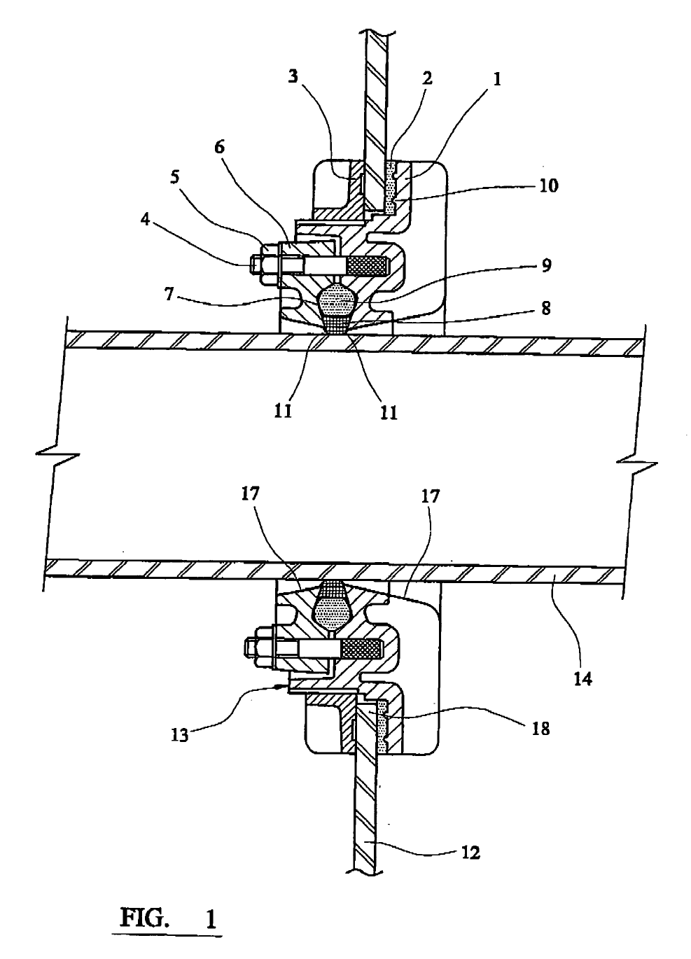

FIG. 1 is a longitudinal sectional view of a pipe seal in accordance with the invention in place on the wall of a tank;

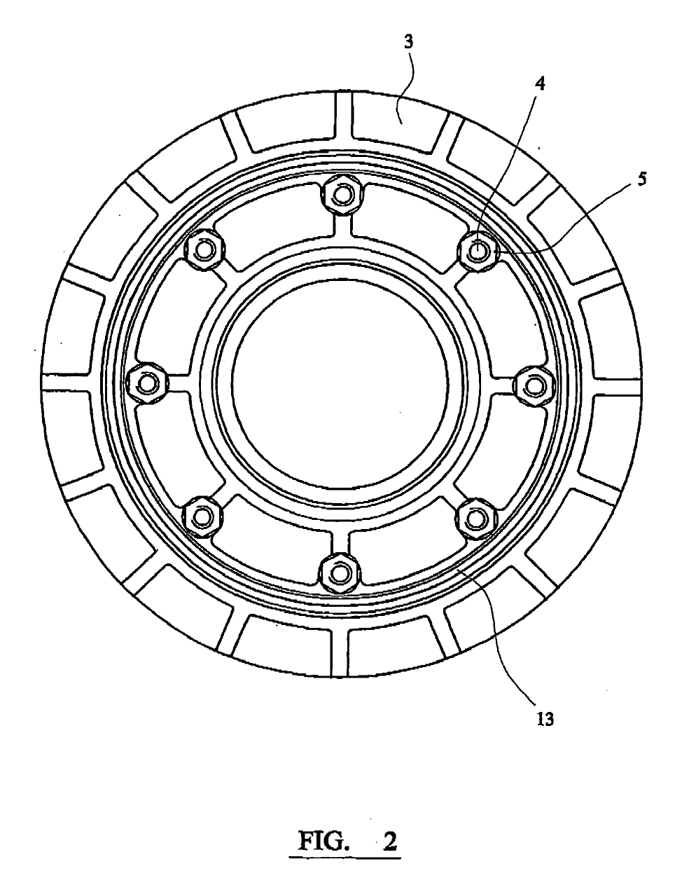

FIG. 2 is an end elevational view;

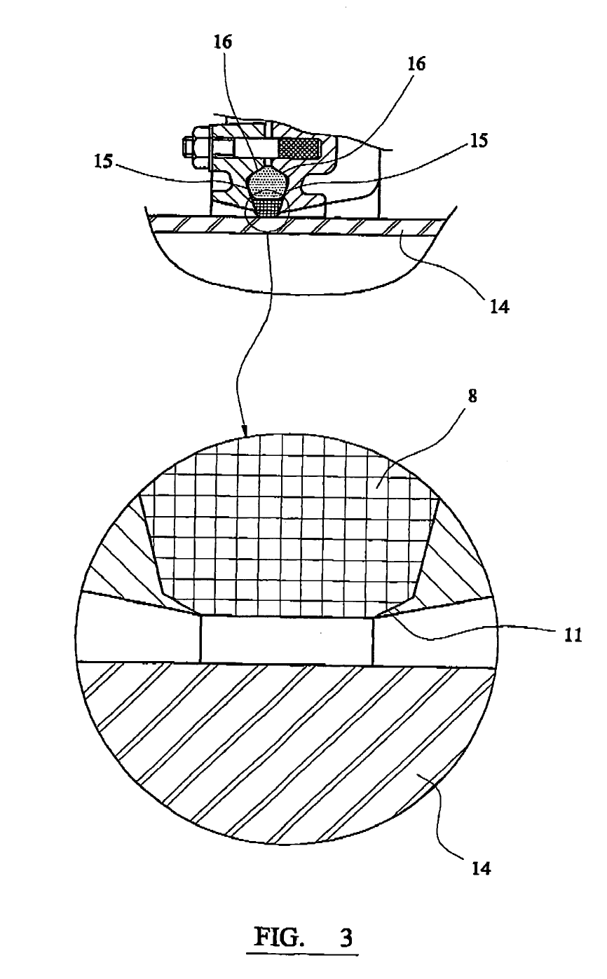

FIG. 3 is a detail of the sealing arrangement;

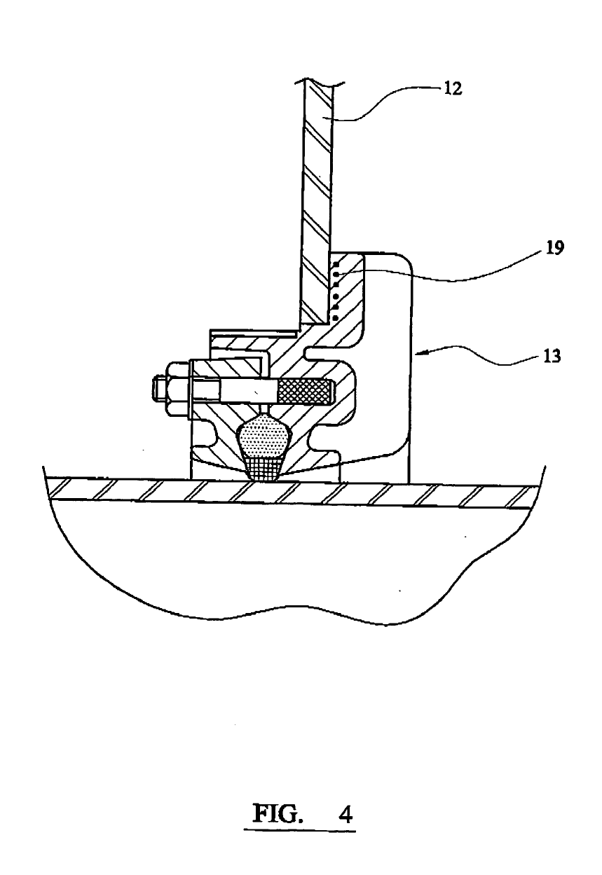

FIG. 4 is a partial sectional view of another embodiment of the invention;

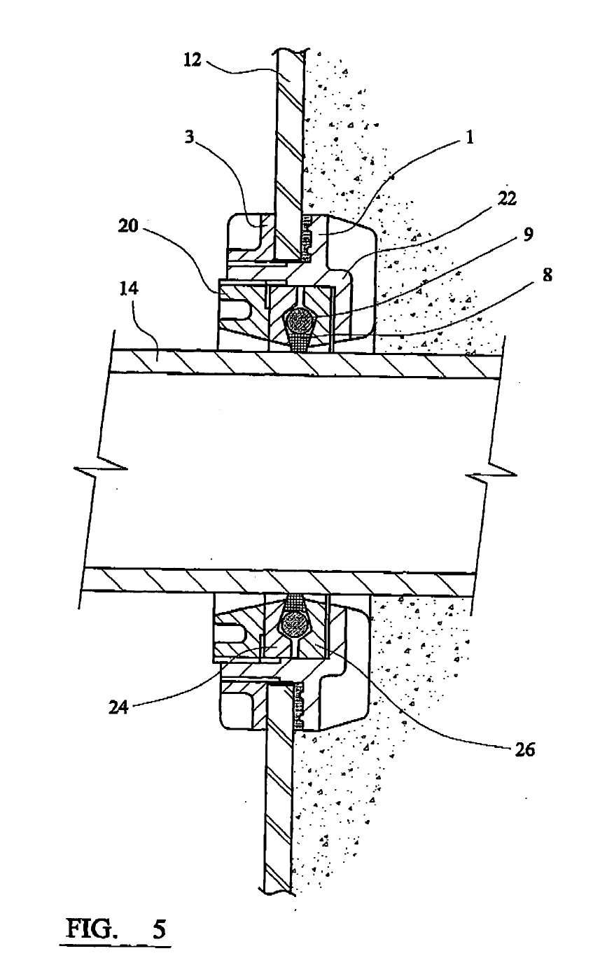

FIG. 5 is a similar view to FIG. 1 of a third embodiment;

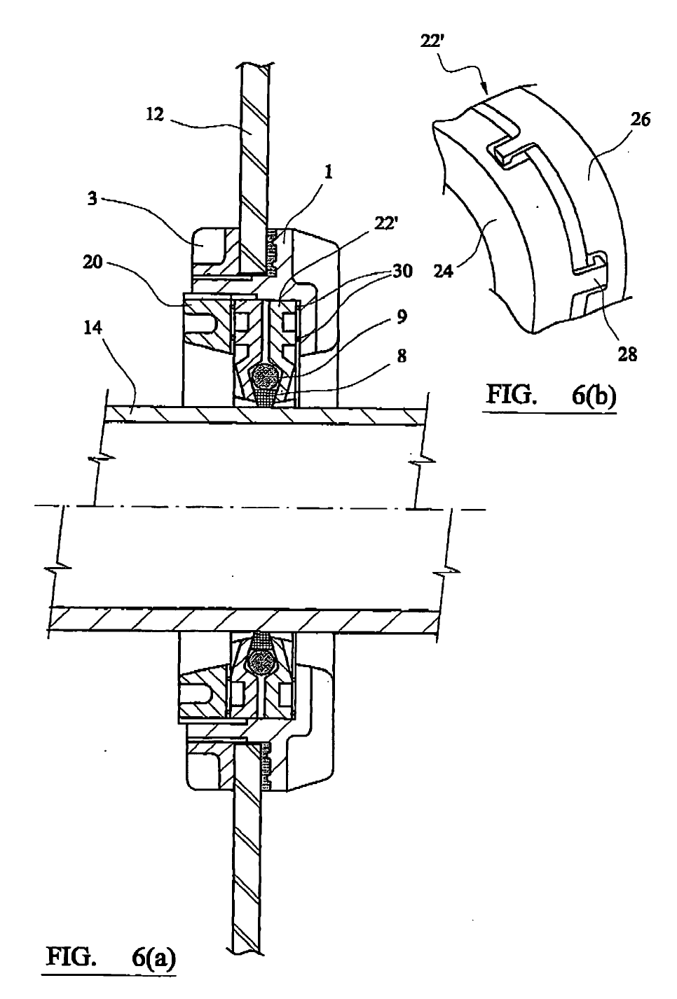

FIG. 6a is a similar view to FIG. 5 with different size pipes/cassette, and FIG. 6b is partial detail of the cassette; and

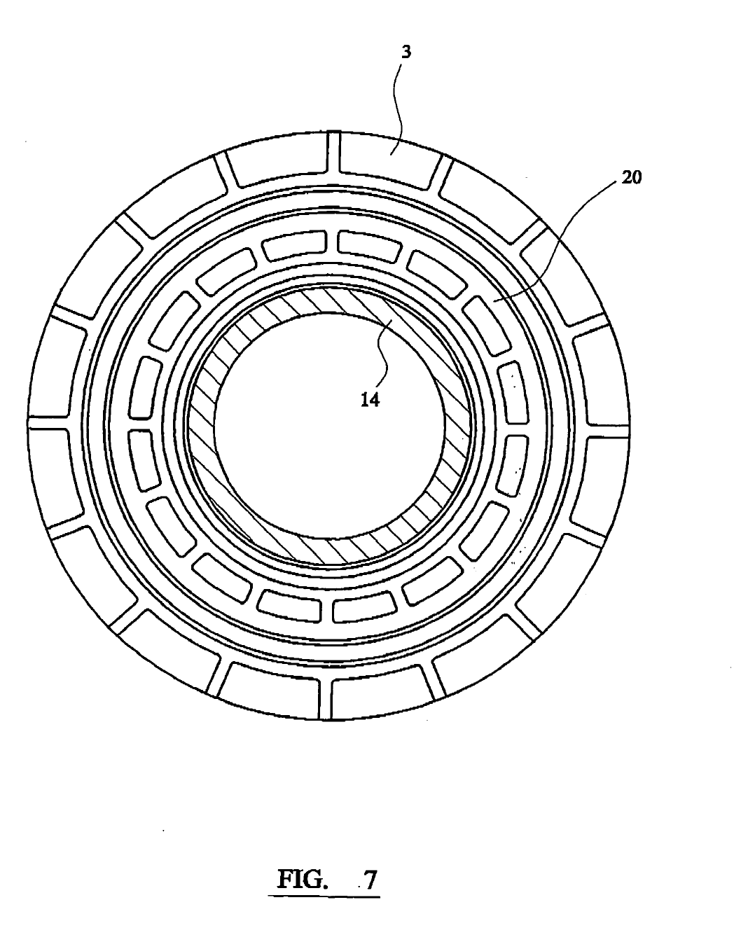

FIG. 7 is a similar view to FIG. 2 of the embodiment of FIG. 5.

Referring to the drawings, and in particular FIGS. 1 to 3, a main body 1 of the pipe seal of the invention 13 has an outer sealing gasket 2 and a ring nut 3 located on its outer periphery. The main body 1 has a series of studs 4 and nuts 5 located on its inner face and these are used to clamp a front plate 6 to the main body 1. A cavity 7, created within the two mating faces of the main body 1 and the front plate 6, houses a seal 8 and an elastomer compression ring 9.

The main body 1, ring nut 3 and the front plate 6 are preferably made of moulded thermoplastic material incorporating glass fibre reinforcement to enhance stiffness. The outer gasket 2 can be made of various materials depending on chemical requirement and may be typically made of nitrile rubber, a cork compound or Teflon. On the face of the main body 1, in contact with the gasket 2, there are located compression pips 10 which enhance sealing. The studs or bolts 4 and nuts 5 are typically made of stainless steel to provide corrosion resistance. The seal 8 is preferably made of a type of Teflon and is in the form of two or three split rings. The choice of a PTFE material such as Teflon provides excellent chemical resistance properties whilst permitting the pipe a degree of axial and radial movement without loss of sealing. A suitable material for the compression ring 9 is nitrile rubber or a thermoplastic elastomer of which Alcrin is an example.

The cavity 7 is provided, at its inner edge, with two retaining lips 11 which are part of the main body 1 and front plate 6 mouldings. The function of these retaining lips 11 is to hold the seal 8 positively within the cavity 7 until the seal 8 is required to be tightened onto the pipe to be sealed.

The pipe seal is installed into the chamber wall 12 and sealed to the pipe 14 as follows.

A single hole 18 of the correct size to match the pipe seal 13 is cut into the chamber wall in a location, which is as close as possible to the apparatus to which the pipe is to be connected, to allow the pipe to pass through the wall at right angles. The pipe seal 13 is pre-assembled with the nuts 5 tightened just sufficiently to lightly nip the front plate 6 onto the compression ring 9. Ring nut 3 is removed and the pipe seal assembly 13 is fitted into the hole 18 and then clamped in place by screwing and fully tightening the ring nut 3.

The pipe 14 to be sealed is passed through the pipe seal 13 and attached to the appropriate termination point within the chamber. The pipe seal 13 permits the pipe 14 to be fitted up to a maximum of 12 degrees from a right angle to the chamber wall 12. To tighten the seal 8 onto the pipe 14 and effect a liquid tight seal, the nuts 5 are progressively tightened to a predetermined torque value. As the nuts 5 are tightened, the compression ring 9 behaves hydraulically applying a radial force onto the outer face of the seal 8, thus forcing the seal 8 into contact with the pipe 14 as well as the cavity wall faces 7.

The wall faces 15 of the cavity 7 are angled inwardly to help to direct the compressed compression ring 9 onto the outer face of the seal 8. Within the cavity 7, the faces 15 compress the seal forcing the compression ring 9 to expand up towards faces 16 and down towards the seal 8.

As the front plate 6 is advanced towards the main body 1 the angled faces 16 force the compression ring 9 down onto the seal 8 thus applying more force to ensure an effective seal.

The pipe seal 13 is able to accommodate the oval cross section of the pipe because the compression ring 9 can move the seal 8 several millimetres in the process of forcing it to close onto the pipe 14. In addition, the compression ring 9 tends to even out the force exerted on the seal 8 around its periphery even though the seal is being forced down onto an oval shape.

The main body 1 and the front plate 6 have radially inner faces 17 which are angled back from the seal 8. This allows the pipe 14 the necessary degree of movement. As illustrated, the faces 17 have an included angle of 24 degrees and they therefore position the pipe 14 and limit its angular movement to 12 degrees from a right angle with the chamber wall 12.

Referring now to FIG. 4, a proportion of the chambers in which the pipe seal will be fitted are made from a thermoplastic material such as high density polypropylene. Such a material is suitable for thermal welding and the use of this method of attaching the pipe seal to the chamber wall can be accommodated by incorporating heating elements 19 into the contact face of the main body 1 and omitting the ring nut 3. Alternatively, the ring nut can be used to hold the pipe seal in place while the welding is carried. The nut may be removed after welding and, e.g., used for fixing another pipe seal.

Turning now to FIGS. 5 to 7, and using like numerals for like parts, the pipe seal design as described hereinabove is ideal for large pipe sizes, for example greater than 150 mm diameter. The stud 4 and nut 5 arrangement allows the seal to be selectively tightened around the pipe circumference, which is preferred when the pipe diameter is large. However, when the pipes sizes become smaller then two considerations must be taken into consideration. The need for selective tightening of the seal 8 and compression ring 9 diminishes as the pipe size becomes smaller and it becomes acceptable to tighten the seal arrangement using a large threaded clamping ring 20 which is in effect equivalent to the face plate 6.

Particularly as pipe sizes become less than 110 mm diameter, the number of sizes that must be accommodated become numerous with only small variations between each size. The design discussed above requires a unique set of parts corresponding to each pipe size. This is a relatively uneconomic solution as the tooling cost for each pipe seal size is significant and sales volumes may not justify the capital investment.

In accordance with this embodiment of the invention, the seal 8 and compression ring 9 are housed within a cassette arrangement 22 specific to a particular pipe size. The cassette 22 is housed within the main body 1 and, within that body, a range of different cassette/pipe size variations can be accommodated. Indeed FIGS. 5 and 6 show the same body accommodating three different pipe sizes: 75 mm in Figure and 50 mm and 63 mm respectively in the upper and lower parts of FIG. 6.

The cassette 22 consists of two halves 24, 26, each half being identical resulting in the need for a single moulding of very simple construction. In this way tool costs for each pipe size are kept to a minimum. The cassette halves 24, 26 can be made to snap, together, e.g. by menas of moulded snap clips 28, and in this way the seal 8 and compression ring 9 can be assembled and held firmly in place prior to and during assembly. A seal 30 may be moulded into the cassette to seal against the body 1.

FIG. 6 illustrates this embodiment in use on two smaller diameter pipes 14, an it can be seen that the size of the cassette 22′ varies to accommodate the different diameters of pipe, but that the other components are unchanged.

Typical pipe size variations that could be accommodated within a single main body are:

Pipe diameter 75 mm up to 110 mm

Pipe diameter 35 mm up to 65 mm

Pipe diameter 19 mm up to 35 mm

The pipe seal of this invention is simple and inexpensive to manufacture and offers the following advantages:

1. A pipe can enter a thin walled chamber at an angle other than a right angle with the chamber wall and be effectively sealed;

2. The pipe seal requires only a single hole to be provided in the chamber wall;

3. The seal in contact with the pipe has a high degree of chemical resistance, can seal on to an oval surface and can be replaced without any disturbance to the pipe work being sealed;

4. The pipe seal has a thin cross sectional profile and projects only a minimum distance in to the chamber; and

5. The outer face of the pipe seal, which may be in contact with the ground, may be free of metallic components.

1. A pipe seal which comprises
a main body portion adapted to be fixed to the wall of a chamber, tank, or the like,
a face plate adapted to be secured to the body portion to surround, in use, a pipe to be sealed,
the body and face plate between them housing a deformable member in contact with a seal,
such that, on forcing the face plate toward the body portion, the deformable member, in use, deforms and presses the seal into sealing contact with the pipe.

2. A seal as claimed in claim 1 wherein the main body portion is generally annular in shape.

3. A seal as claimed in claim 1 wherein the main body portion is attached to the chamber wall by a ring nut.

4. A seal as claimed in claim 2 wherein the body is welded or heat sealed to the wall.

5. A seal as claimed in any of claims 1 to 4 wherein the face plate is attached to the body by one or more bolts and associated nuts.

6. A seal as claimed in any of claims 1 to 4 wherein the deformable member and seal are contained within a cassette arrangement.

7. A seal as claimed in claim 6 wherein the face plate comprises a clamping ring.

8. A seal as claimed in of claims 1 to 7 wherein the deformable member is a ring of elastomeric material.

9. A seal as claimed in any of claims 1 to 8 wherein the seal is also of an elastomeric material.

10. A seal as claimed in claim 10 wherein the seal is a chemically inert material such as polytetrafluoroethylene.

11. A seal as claimed in any of claims 1 to 10 wherein the seal is in the form of a plurality of split rings so the it can be removed and replaced when necessary without having to disconnect the pipework.

12. A seal as claimed in any of claims 1 to 11 allowing a pipe passing therethrough to deviate up to an angle of 12° from normal to the wall.
